(19) United States
(12) Patent Application Publication
(10) Pub. No.: US 2016/0353435 A1
(43) Pub. Date: Dec. 1, 2016

(54) RANDOM ACCESS WITH MULTIPLE TIME SLOTS IN A HIGH EFFICIENCY WIRELESS LOCAL-AREA NETWORK

(71) Applicant: Chittabrata Ghosh, Fremont, CA (US)

(72) Inventor: Chittabrata Ghosh, Fremont, CA (US)

(21) Appl. No.: 14/864,238

(22) Filed: Sep. 24, 2015

Related U.S. Application Data
(60) Provisional application No. 62/167,386, filed on May 28, 2015.

(51) Int. Cl. H04W 72/04; H04W 74/08

(52) U.S. Cl. CPC H04W 72/0446; H04W 74/0833; H04W 84/12

(57) ABSTRACT

Apparatuses, computer readable media, and methods for random access with multiple time slots in a high efficiency wireless (HEW) local-area network are disclosed. An apparatus of a HEW master station is disclosed. The HEW master station includes transceiver circuitry and processing circuitry configured to generate a random access trigger frame (TF-R) that indicates one or more resource units (RUs) and a number of time slots for the one or more RUs, and transmit the TF-R to a plurality of HEW stations. The transceiver circuitry and processing circuitry may be further to generate the TF-R that indicates the one or more RUs and the number of time slots for the one or more RUs for each of one or more access categories.

### PRIORITY CLAIM

This application claims the benefit of priority under 35 USC 119(e) to U.S. Provisional Patent Application Ser. No. 62/167,386, filed May 28, 2015, which is incorporated herein by reference in their entirety.

### TECHNICAL FIELD

Embodiments relate to Institute of Electrical and Electronic Engineers (IEEE) 802.11. Some embodiments relate to high-efficiency wireless local-area networks (HEWs). Some embodiments relate to IEEE 802.11ax. Some embodiments relate to random trigger frames that indicate multiple time slots for uplink use. Some embodiments relate to random trigger frames for battery constrained and battery unconstrained HEW devices. Some embodiments relate to trigger frames for random access that indicate an access category for resource units and/or time slots.

### BACKGROUND

Efficient use of the resources of a wireless local-area network (WLAN) is important to provide bandwidth and acceptable response times to the users of the WLAN. However, often there are many devices trying to share the same resources and the devices may interfere with one another. Moreover, wireless devices may need to operate with both newer protocols and with legacy device protocols.

Thus, there are general needs for improved methods, apparatuses, and computer readable media for random access with multiple time slots.

### BRIEF DESCRIPTION OF THE DRAWINGS

The present disclosure is illustrated by way of example and not limitation in the figures of the accompanying drawings, in which like references indicate similar elements and in which:

FIG. 1 illustrates a wireless network in accordance with some embodiments;

FIG. 2 illustrates a method for orthogonal frequency division multiple access distributed channel access (ODCA) in accordance with some embodiments;

FIG. 3 illustrates a method for time-slotted ODCA in accordance with some embodiments;

FIG. 4 illustrates subfields of a trigger frame in accordance with some embodiments.

FIG. 5 illustrates subfields of a trigger frame in accordance with some embodiments;

FIG. 6 illustrates a method performed by a HEW master station for random access with multiple time;

FIG. 7 illustrates a method performed by a HEW station for random access with multiple time; and

FIG. 8 illustrates a HEW device in accordance with some embodiments.

### DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

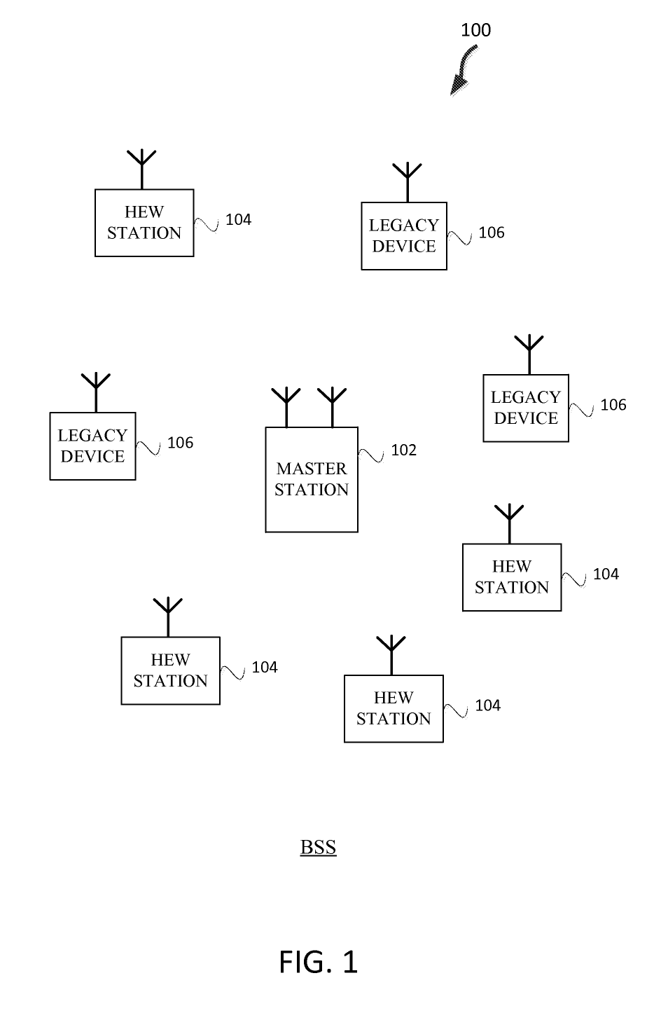

FIG. 1 illustrates a WLAN 100 in accordance with some embodiments. The WLAN may comprise a basis service set (BSS) 100 that may include a master station 102, which may be an AP, a plurality of high-efficiency wireless (HEW) (e.g., IEEE 802.11ax) STAs 104 and a plurality of legacy (e.g., IEEE 802.11n/ac) devices 106.

The master station 102 may be an AP using the IEEE 802.11 to transmit and receive. The master station 102 may be a base station. The master station 102 may use other communications protocols as well as the IEEE 802.11 protocol. The IEEE 802.11 protocol may be IEEE 802.1 lax. The IEEE 802.11 protocol may include using orthogonal frequency division multiple-access (OFDMA), time division multiple access (TDMA), and/or code division multiple access (CDMA). The IEEE 802.11 protocol may include a multiple access technique. For example, the IEEE 802.11 protocol may include space-division multiple access (SDMA) and/or multiple-user multiple-input multiple-output (MU-MIMO).

The legacy devices 106 may operate in accordance with one or more of IEEE 802.11a/b/g/n/ac/ad/af/ah/aj, or another legacy wireless communication standard. The legacy devices 106 may be STAs or IEEE STAs. The HEW STAs 104 may be wireless transmit and receive devices such as cellular telephone, smart telephone, handheld wireless device, wireless glasses, wireless watch, wireless personal device, tablet, or another device that may be transmitting and receiving using the IEEE 802.11 protocol such as IEEE 802.11ax or another wireless protocol. In some embodiments, the HEW STAs 104 may be termed high efficiency (HE) stations.

The master station 102 may communicate with legacy devices 106 in accordance with legacy IEEE 802.11 communication techniques. In example embodiments, the master station 102 may also be configured to communicate with HEW STAs 104 in accordance with legacy IEEE 802.11 communication techniques.

In some embodiments, a HEW frame may be configurable to have the same bandwidth as a subchannel. The bandwidth of a subchannel may be 20 MHz, 40 MHz, or 80 MHz, 160 MHz, 320 MHz contiguous bandwidths or an 80+80 MHz (160 MHz) non-contiguous bandwidth. In some embodiments, the bandwidth of a subchannel may be 1 MHz, 1.25 MHz, 2.03 MHz, 2.5 MHz, 5 MHz and 10 MHz, or a combination thereof or another bandwidth that is less or equal to the available bandwidth may also be used. In some embodiments the bandwidth of the subchannels may be based on a number of active subcarriers. In some embodiments the bandwidth of the subchannels are multiples of 26 (e.g., 26, 52, 104, etc.) active subcarriers or tones that are spaced by 20 MHz. In some embodiments the bandwidth of the subchannels is 256 tones spaced by 20 MHz. In some embodiments the subchannels are multiple of 26 tones or a multiple of 20 MHz. In some embodiments a 20 MHz subchannel may comprise 256 tones for a 256 point Fast Fourier Transform (FFT).

A HEW frame may be configured for transmitting a number of spatial streams, which may be in accordance with MU-MIMO. In other embodiments, the master station 102, HEW STA 104, and/or legacy device 106 may also implement different technologies such as code division multiple access (CDMA) 2000, CDMA 2000 1×, CDMA 2000 Evolution-Data Optimized (EV-DO), Interim Standard 2000 (IS-2000), Interim Standard 95 (IS-95), Interim Standard 856 (IS-856), Long Term Evolution (LTE), Global System for Mobile communications (GSM), Enhanced Data rates for GSM Evolution (EDGE), GSM EDGE (GERAN), IEEE 802.16 (i.e., Worldwide Interoperability for Microwave Access (WiMAX)), BlueTooth®, or other technologies.

Some embodiments relate to HEW communications. In accordance with some IEEE 802.1 lax embodiments, a master station 102 may operate as a master station which may be arranged to contend for a wireless medium (e.g., during a contention period) to receive exclusive control of the medium for an HEW control period. In some embodiments, the HEW control period may be termed a transmission opportunity (TXOP). The master station 102 may transmit a HEW master-sync transmission, which may be a trigger frame or HEW control and schedule transmission, at the beginning of the HEW control period. The master station 102 may transmit a time duration of the TXOP and sub-channel information. During the HEW control period, HEW STAs 104 may communicate with the master station 102 in accordance with a non-contention based multiple access technique such as OFDMA or MU-MIMO. This is unlike conventional WLAN communications in which devices communicate in accordance with a contention-based communication technique, rather than a multiple access technique. During the HEW control period, the master station 102 may communicate with HEW stations 104 using one or more HEW frames. During the HEW control period, the HEW STAs 104 may operate on a sub-channel smaller than the operating range of the master station 102. During the HEW control period, legacy stations refrain from communicating.

In accordance with some embodiments, during the master-sync transmission the HEW STAs 104 may contend for the wireless medium with the legacy devices 106 being excluded from contending for the wireless medium during the master-sync transmission. In some embodiments the trigger frame may indicate an uplink (UL) UL-MU-MIMO and/or UL OFDMA control period.

In some embodiments, the multiple-access technique used during the HEW control period may be a scheduled OFDMA technique, although this is not a requirement. In some embodiments, the multiple access technique may be a time-division multiple access (TDMA) technique or a frequency division multiple access (FDMA) technique. In some embodiments, the multiple access technique may be a space-division multiple access (SDMA) technique.

The master station 102 may also communicate with legacy stations 106 and/or HEW stations 104 in accordance with legacy IEEE 802.11 communication techniques. In some embodiments, the master station 102 may also be configurable to communicate with HEW stations 104 outside the HEW control period in accordance with legacy IEEE 802.11 communication techniques, although this is not a requirement.

In some embodiments, the HEW STA 104 may be battery constrained. For example, in some embodiments the HEW STA 104 may be Internet of Things (IoT) wireless devices such as sensors or controllers. The HEW STAs 104 may sleep for extended periods of times and wake-up according to a schedule that may be provided by a master station 102 or another controlling devices such as a smart controller. A battery constrained HEW STA 104 may mean that the HEW STA 104 is battery constrained in comparison to other non-battery constrained HEW STA 104. For example, a smart phone may be a non-battery constrained HEW STA 104 and a temperature sensor may be a battery constrained HEW STA 104.

In example embodiments, the HEW STA 104 and/or the master station 102 are configured to perform the methods and functions herein described in conjunction with FIGS. 1-8.

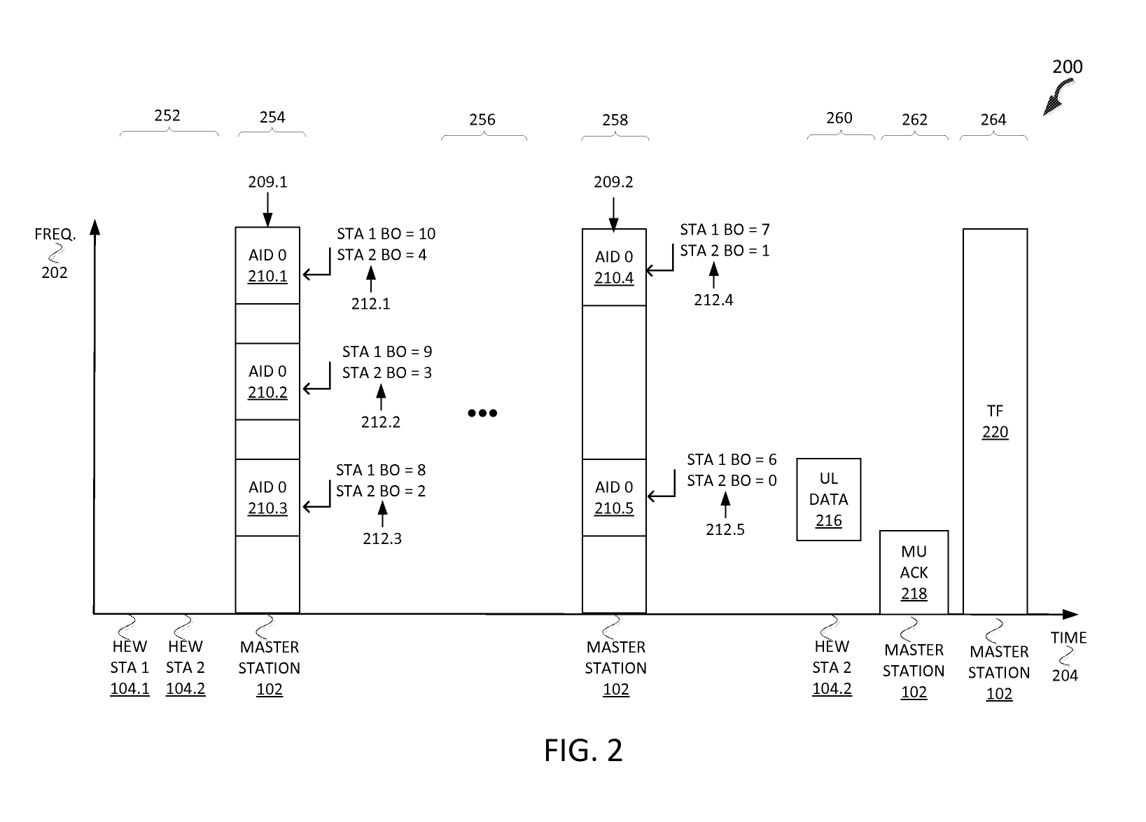

FIG. 2 illustrates a method for orthogonal frequency division multiple access distributed channel access (ODCA) in accordance with some embodiments. Illustrated in FIG. 2 is frequency 202 along a vertical axis and time 204 along a horizontal axis. The device that is transmitting is indicated below the time 204. The operation is indicated along the top. The method 200 begins at operation 252. Both HEW STA 1 104.1 and HEW STA 2 104.2 may have data to send to master station 102.

The method 200 continues at operation 254 with the master station 102 transmitting a trigger frame for random access (TF-R) 209.1. HEW STA 1 104.1 and HEW STA 2 104.2 may attempt to gain a slot and transmit based on the TR-R 209.1. The TF-Rs 209 include an indication of a number of resource units (RUs) or resource allocations. The RUs may be subchannels. The TF-R 209 may include a duration. In some embodiments, the duration may be per slot or may be a single duration for each slot. The subchannels may be smaller than 40 MHz or 20 MHz. For example, the subchannels may be 10 MHz, 5 MHz, 2.03 MHz, or another value as disclosed herein. In some embodiments, the master station 102 may indicate a RU with an association identification (AID) of zero, AID 0 210. HEW STA 104 may randomly select a resource allocation indicated in the TF-R 209. For example, in some embodiments, HEW STA 1 104.1 and HEW STA 2 104.2 may randomly select a backoff counter (BO). For example, HEW STA 1 104.1 may randomly select a BO of 11 and HEW STA 2 104.2 may randomly select a BO of 5. HEW STA 1 104.1 and HEW STA 2 104.2 may then decrement the BO by 1 for every RU assigned for AID 0 210 within the TF-R 209.1.

STA 1 BO=10 and STA 2 BO=4 at 212.1 when HEW STA 1 104.1 and HEW STA 2 104.2 access AID 0 210.1. HEW STA 1 104.1 and HEW STA 2 104.2 may continue to attempt to use an AID 0 210 subchannel with STA 1 BO=9 STA 2 BO=3 at 212.2, and STA 1 BO=8 STA 2 BO=2 at 212.3. Neither HEW STA 1 104.1 nor HEW STA 2 104.2 may get an RU in the transmission opportunity for random access initiated by TF-R 209.1.

The method 200 continues at operation 256 where other HEW STAs 104 may transmit uplink data to the master station 102 and the master station 102 may acknowledge the uplink data between TR-R 209.1 and TR-R 209.2. These operations are represented by the ellipsis.

The method 200 continues at operation 258 with the master station 102 transmitting another TF-R 209.2. HEW STA 1 104.1 and HEW STA 2 104.2 may continue to count down the BO by 1 for each RU indicated by AID 0 210. STA 1 BO=7 STA 2 BO=1 at 210.4, and STA 1 BO=6 STA 2 BO=0 at 210.5. HEW STA 2 104.2 may determine that it will attempt to transmit using RU AID 0 214.5 since its BO counted down to zero. In some embodiments, HEW STA 104 may select RU in TF-R 209 in a different manner. For example, the TF-R 209 may include a RU map and the HEW STA 104 may generate a BO and use the RU map to determine whether or which RU to use.

The method 200 continues at operation 260 with HEW STA 2 104.2 transmitting uplink (UL) data 216 in accordance with the RU indicated by AID 0 214.5. Other HEW STA 104 may transmit UL data (not illustrated) as well.

The method 200 continues at operation 262 with the master station 102 transmitting a multi-user (MU) acknowledgement (ACK) to the UL data 218. The UL ACK 218 may include an acknowledgement to the UL data 216 and may include acknowledgements to other UL data (not illustrated) that may have been transmitted to the master station 102 in accordance with TF-R 209.2.

The method 200 continues at operation 264 with the master station 102 transmitting a TF 220. The TF 220 may indicate a resource allocation for HEW STAs 104 and may not include an opportunity for a HEW STA 104 to randomly select a RU. For example, the resource allocation may include a HEW STA ID, assigned subchannels, and duration of access for all the resources that are allocated by the TF 220. The method of accessing the RUs or resource allocations in a TF-R 209 may be termed OFDMA-based distributed channel access (ODCA). In some embodiments, HEW STAs 104 do not reduce the BO based on the TF 220. The method 200 may end.

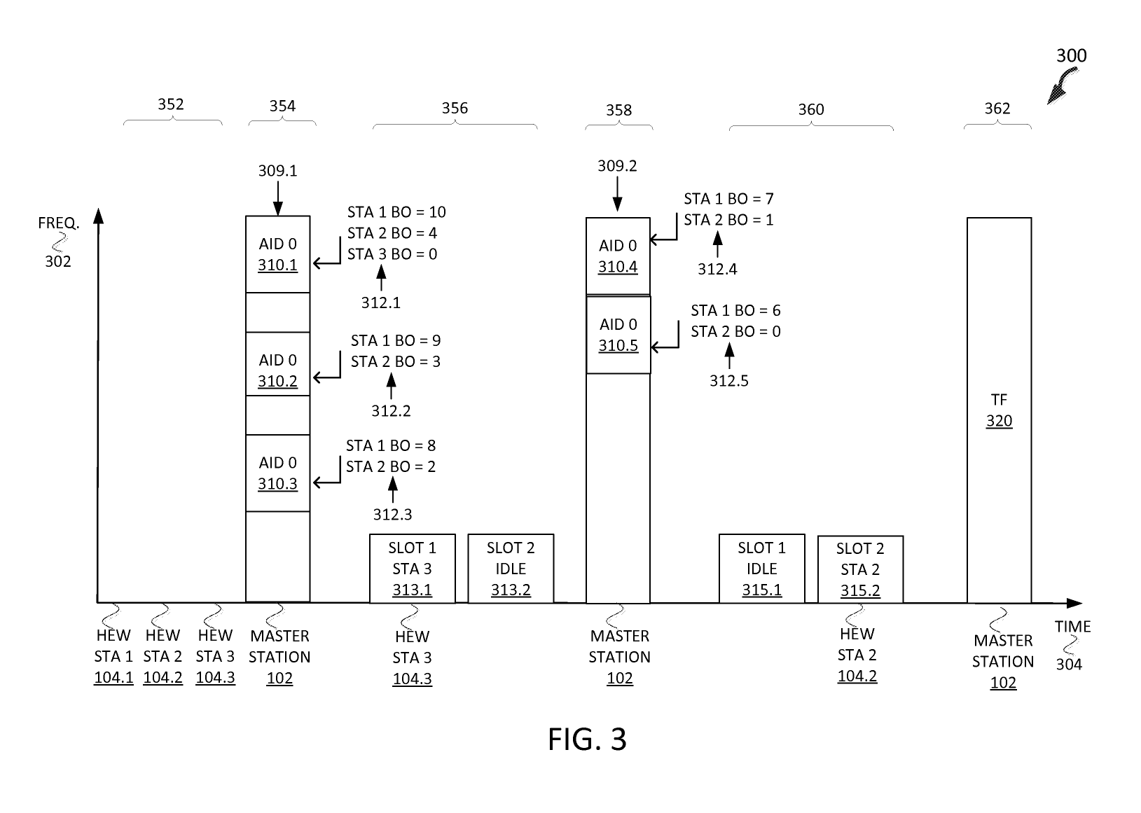

FIG. 3 illustrates a method for time-slotted ODCA in accordance with some embodiments. Illustrated in FIG. 3 is frequency 302 along a vertical axis and time 304 along a horizontal axis. The device that is transmitting is indicated below the time 204. The operation is indicated along the top. The method 300 begins at operation 352. HEW STA 1 104.1, HEW STA 2 104.2, and HEW STA 3 104.3 may have data to send.

The method 300 continues at operation 354 with the master station 102 transmitting a TF-R 390.1 with time slots. HEW STA 1 104.1, HEW STA 2 104.2, and HEW STA 3 104.3 may attempt to RU indicated by the TF-R-TS 309.1. The TF-R 309 with time slots may include an indication of a number of RUs or resource allocations, and include an indication of a number of time-slots. TF-R 309.1 with time slots indicates that there are two time slots for each RU. The RU may be subchannels and a duration. The subchannels may be smaller than 40 MHz or 20 MHz. For example, the subchannels may be 2.5 MHz or another value as disclosed herein. In some embodiments, the master station 102 may indicate a RU with an association identification (AID) of zero, AID 0 210. HEW STAs 104 may randomly select a resource allocation indicated in the TF-R 309.1 with time slots.

For example, in some embodiments, HEW STA 1 104.1, HEW STA 2 104.2, and HEW STA 3 104.3 may randomly select a backoff counter (BO). For example, HEW STA 1 104.1 may randomly select a BO of 11; HEW STA 2 104.2 may randomly select a BO of 5; and HEW STA 3 104.3 may randomly select a BO of 1. HEW STA 1 104.1, HEW STA 2 104.2, and HEW STA 3 104.3 may then decrement the BO by 1 for every RU assigned for AID 0 210 within the TF-R 309.1 with time slots. HEW STA 3 104.3 selects (or wins) RU at AID 0 310.1 and HEW STA 1 104.1 selects (or wins) RU at AID 0 310.5. The HEW STA 104 may randomly select a time slot of the available time slots. As illustrated, HEW STA 3 104.3 selects slot 1 313.1 and HEW STA 2 104.2 selects slot 2 315.2.

The method 300 continues at operation 356 with HEW STA 3 104.3 transmitting at slot 1 313.1. Other HEW STAs 104 may also transmit simultaneously or at slot 1 313.1. Moreover, the master station 102 may acknowledge the transmissions. Additionally, slot 2 313.2 may remain idle.

The method 300 continues at operation 358 with the master station 102 transmitting TF-R 309.2 with time slots. As discussed above, HEW STA 2 104.2 selects the RU at AID 0 310.5. The method 300 continues at operation 360 with HEW STA 2 104.2 transmitting at slot 2 314.2. Other HEW STAs 104 may also transmit simultaneously or at slot 1 315.1. Moreover, the master station 102 may acknowledge the transmissions. Additionally, slot 2 315.1 may remain idle.

The method 300 may continue at operation 362 with the master station 102 transmitting a TF 320. In some embodiments, the HEW STAs 104 do not count down the BO based on the TF 320.

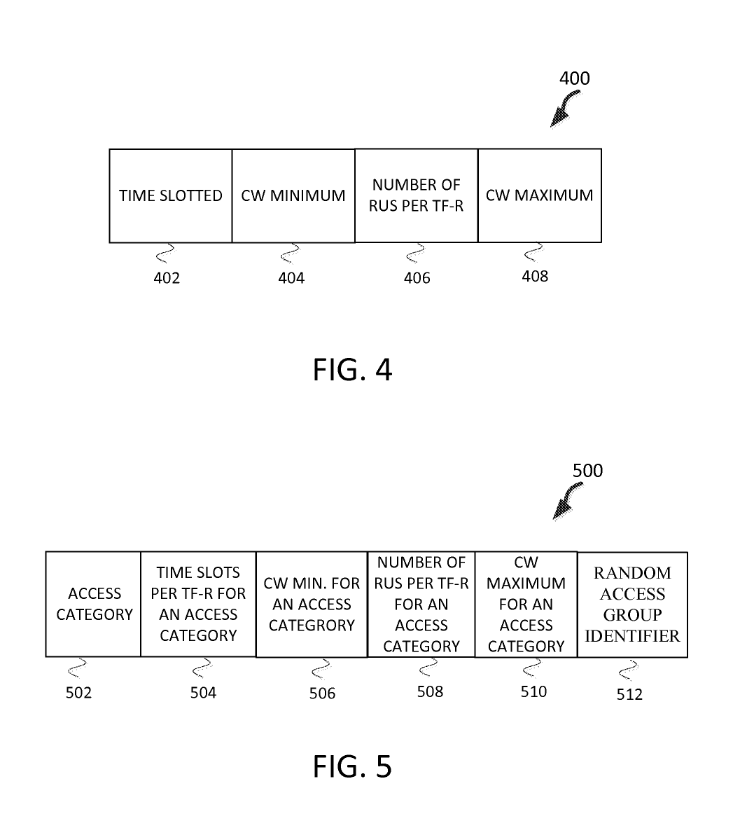

In some embodiments the HEW STAs 104 are configured to access the RU indicated in the TF-Rs using a different method. The TF-R may indicate one to a fixed number of time slots. In some embodiments the fixed number is 16 or less. In some embodiments, the TF-R may include one more of the sub-fields disclosed in conjunction with FIGS. 4 and 5.

FIG. 4 illustrates subfields 400 of a trigger frame in accordance with some embodiments. The subfields 400 may be for HEW STAs 104 that are not battery constrained. Illustrated in FIG. 4 is time slotted 402 subfield, contention window (CW) minimum 404 subfield, number of RUs per TF-R 406 subfield, and CW maximum 408 subfield. Time slotted 402 subfield may be 1 bit of information in a TF and/or TF-R that indicates whether the master station 102 allows time-slotted ODCA or not. A value of 1 may indicate 2 slots per TF-R transmission and a value of 0 may indicate ODCA (1 slot per TF-R).

The CW minimum 404 subfield may indicate the minimum CW value for contention of RUs. The number of RUs per TF-R 406 subfield may indicate the number of RUs assigned by the master station 102 in the current TF-R. The CW maximum 408 subfield indicates the maximum contention window value for re-transmissions.

FIG. 5 illustrates subfields 500 of a trigger frame in accordance with some embodiments. The subfields 500 may be for HEW STAs 104 where there are multiple categories of HEW STAs 104. For example, there may be both battery constrained HEW STAs 104 and none battery constrained HEW STA 104. The master station 102 may be configured to determine whether or not HEW STAs 104 are battery constrained based on their behavior or based on configurations that the HEW STA 104 may transmit to the master station 102. The master station 102 may determine the HEW STA 104 are battery constrained based on a transmit power used by the HEW STA 104.

Illustrated in FIG. 5 is access category 502, time slots per TF-R for an access category 504, CW minimum for an access category 506, number of RUs per TF-R for an access category 508, CW maximum for an access category 510, and a random access group identifier 512.

The access category 504 subfield indicates the type of STAs for which the following sub-fields are defined. For example, a value of 1 indicates HEW STAs 104 that are battery constrained or low power HEW STAs 104 that may be IoTs wireless devices, while a value of 0 indicates HEW STAs 104 that are not battery constrained. The time Slots per TF-R for an access category 504 subfield is a function of the access category sub-field defined above. The master station 102 may define multiple time slots per TF-R for battery constrained HEW STAs 104 while only 1 or 2 time slots for other type of STAs. In the time Slots per TF-R for an access category 504 subfield, the master station 102 indicates the number of time slots (for example, 5 slots) per TF-R assigned for HEW STAs 104 in a specific access category.

In case of access by STAs from multiple access categories, there will be a sub-field of this for each access category. So, for example, in some embodiments a category for battery constrained HEW STA 104 may receive 5 slots and a category for non-battery constrained HEW STAs 104 may receive 1 slot.

The CW minimum for an access category 506 subfield indicates the value of the minimum contention window for a specific access category. In case of access by STAs from multiple access categories, there will be a sub-field of this for each access category.

The number of RUs per TF-R for an access category 508 subfield indicates the number of RUs per TF-R that the master station 102 intends to assign to HEW STAs 104 in a specific access category. In case of access by HEW STAs from multiple access categories, there will be a number of RUs per TF-R for an access category 508 for each access category.

The CW maximum for an access category 510 subfield indicates the value of the maximum contention window allowed for HEW STAs 104 in a specific access category. In case of access by HEW STAs 104 from multiple access categories, there will be a CW maximum for an access category 510 subfield for each access category. There may be two categories. HEW STA 104 non-battery constrained and HEW STA 104 battery constrained, which may be IoT wireless devices. There may be additional categories.

The random access group identifier 512 may be a group identifier that identifies a group of HEW STAs 104. The master station 102 may be configured to assign one or more of the HEW STAs 104 to a random access group. The master station 102 may assign HEW STAs 104, for example, when the HEW STA 104 associates with the master station 102. The maser station 102 may then generate a TF-R with the random access group identifier to indicate that the TF-R is for the HEW stations 104 that are a member of the random access group identified by the random access group identifier 512.

In some embodiments, a TF-R is a random slotted ALOHA method and hence, achieves a maximum throughput of 37%. However, improper choice of a back-off mechanism may lead to a reduced efficiency compared to that of slotted ALOHA. Splitting the collision domain between two or more time slots leads to increased efficiency when compared to UL transmissions in a single time slot. However, in specific scenarios, slotted time access may not be beneficial, for example, for small number of STAs.

For Internet of Things (IoT) networks based on IEEE 802.11ax, HEW STAs may support peer-to-peer communication. A higher number of time slots are beneficial within a single TF-R-based access when increasing the number of HEW STAs that are contending simultaneously for resource allocations or RU. Some IoT HEW STAs 104 may wake up in groups that may be in large numbers and may use ODCA with a higher number of time slots per ODCA access.

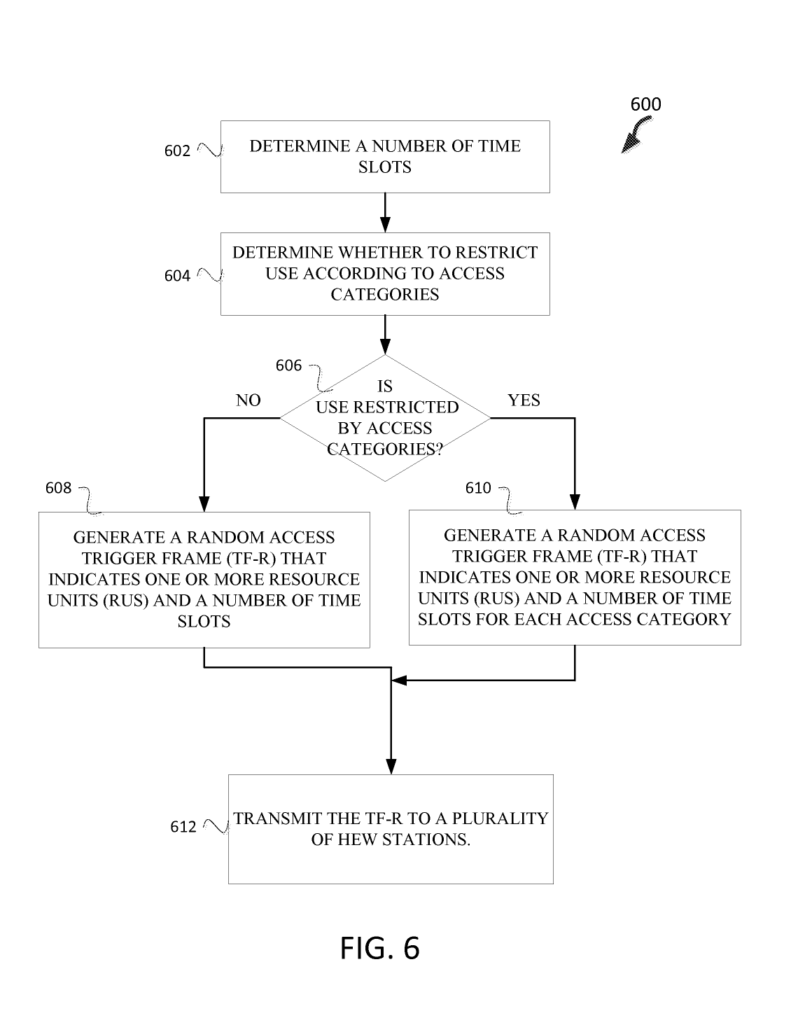

FIG. 6 illustrates a method 600 performed by a HEW master station for random access with multiple time. The method 600 begins at operation 602 with determining a number of time slots. The master station 102 may be configured to determine a number of time slots for a transmission opportunity for random access (TxOP-R). For example, the master station 102 may determine that one time slot should be used because there are not a large number of HEW stations 104 communicating with the master station 102. The master station 102 may determine to two or more time slots if there are more HEW stations 104 than RUs than in the TxOP-R. The master station 102 may determine to create two or more time slots if there are several or more HEW stations 104 that are battery constrained that may participate in the TxOP-R.

The method 600 continues at operation 604 with determining whether to restrict use according to access categories. For example, the master station 102 may determine that there are many battery constrained HEW stations 104 and some non-battery constrained HEW stations 104 and to restrict use according to the whether the HEW station 104 is battery constrained or not battery constrained.

The method 600 continues at operation 606 with is use restricted by access categories. If the use of the TxOP-R is not restricted by access categories then the method 600 continues at operation 608 with generating a TF-R that indicates one or more RUs and the number of times slots. In some embodiments, if the use of the TxOP-R is not restricted by access categories, the TxOP-R may be restricted to only members of a random access group identified by the random access group identifier 512. The master station 102 may then generate the TF-R with an indication of the random access group identifier 512. The method 600 continues at operation 612 with transmitting the TF-R to a plurality of HEW stations.

If the use of the TxOP-R is restricted by access categories at operation 606, then the method 600 continues at operation 610 with generating a TF-R that indicates one or more RUs and a number of time slots for each access category. For example, the master station 102 may indicate that only battery constrained HEW stations 104 may use any of the RU and time slots. In another example, the master station 102 may determine that a first time slot may be used by non-battery constrained HEW STAs 104 and that a second and third time slot may be used by battery constrained HEW STAs 104. In another example, the master station 102 may determine that a first half of RUs (for example subchannels) may be used by battery constrained HEW STAs 104 and that the remaining RUs may be used by non-battery constrained HEW STAs 104.

The master station 102 may generate the TF-R where for each of the one or more access categories one or more of the following may be indicated: a contention window (CW) minimum value subfield, a number of resource units (RUs) subfield, and a CW maximum value subfield. The method 600 continues at operation 612 with transmitting the TF-R to a plurality of HEW stations. The method 600 may end.

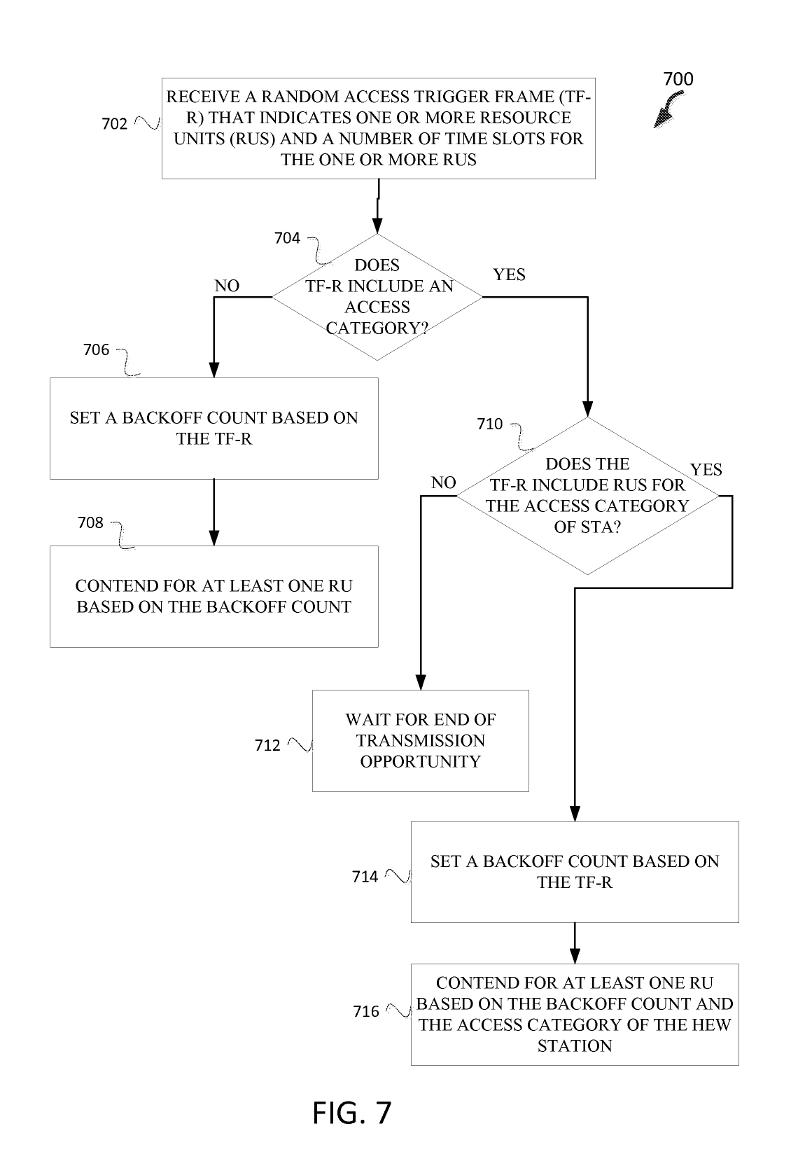

FIG. 7 illustrates a method 700 performed by a HEW station for random access with multiple time. The method 700 begins at operation 702 with receiving a TF-R that indicates one or more RUs and a number of time slots.

The method 700 continues at operation 704 with does the TF-R include an access category. If the TF-R does not include an access category, then the method 700 continues at operation 706 with setting a backoff count based on the TF-R. For example, the HEW STA 104 may set a backoff count as described herein. In some embodiments, the HEW STA 104 may be check for a random access group identifier 512 in the TF-R. If the TF-R includes the random access group identifier 512, then the HEW STA 104 checks if the HEW STA 104 is a member of the random access group identified by the random access group identifier 512. If the HEW STA 104 is not a member of the random access group, then the method ends. Otherwise, the HEW STA 104 continues to operation 708. The method 700 continues at operation 708 with contend for at least one RU based on the backoff count. For example, a HEW STA 104 may tick down the backoff count for each RU as described herein.

If there is an access category in the TF-R at operation 704, then the method 700 continues at operation 710 with does the TR-R include RUs for the access category of the STA. For example, the HEW STA 104 may be a non-battery constrained HEW STA 104 and the TF-R may or may not contain RUs for non-battery constrained HEW STAs 104. The method 700 continues at operation 712 with waiting for end of TxOP. For example, if the TF-R does not have an access category for the HEW STA 104, then the HEW STA 104 may set the NAV until the end of the TxOP-R.

If the TxOP-R does have one or more RUs that match the category of the HEW station at operation 710, then the method 700 continues at operation 714 with setting a backoff count based on the TF-R. For example, the HEW STA 104 may set the backoff count as described herein.

In some embodiments, the TF-R may include one or more of the following for each access category: a contention window (CW) minimum value subfield, a number of resource units (RUs) subfield, and a CW maximum value subfield. The HEW STA 104 may generate the backoff count based on the CW minimum value and the CW maximum value.

The method 700 continues at operation 716 with contending for at least one RU based on the backoff count and the access category of the HEW STA. For example, the TF-R may indicate that the first half of the RUs and the first time slot is for the access category of the HEW STA 104. The HEW STA 104 may contend for these resources as described herein with the backoff count. For example, the HEW STA 104 may tick down the backoff count for each RU and each time slot, or may tick down for each RU. The HEW STA 104 may randomly select an RU and time slot in other ways.

In some embodiments, the access categories may include one or more of the following: battery constrained, non-battery constrained, has recently transmitted, has not transmitted in a longer time, is associated with the master station, is not associated with the master station, has an application running that requires real time interaction with user, etc.

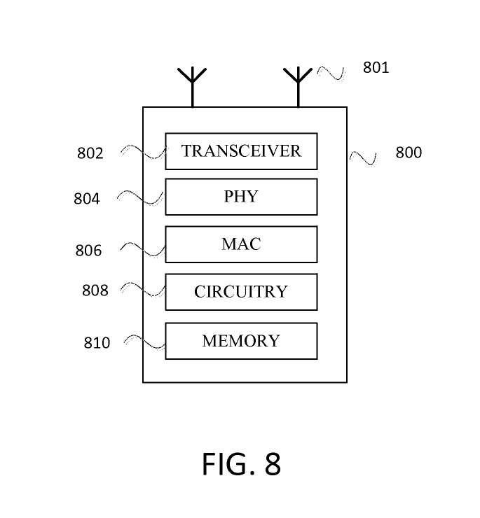

FIG. 8 illustrates a HEW device 800 in accordance with some embodiments. HEW device 800 may be an HEW compliant device that may be arranged to communicate with one or more other HEW devices, such as HEW STAs 104 (FIG. 1) or master station 102 (FIG. 1) as well as communicate with legacy devices 106 (FIG. 1). HEW STAs 104 and legacy devices 106 may also be referred to as HEW devices and legacy STAs, respectively. HEW device 800 may be suitable for operating as master station 102 (FIG. 1) or a HEW STA 104 (FIG. 1). In accordance with embodiments, HEW device 800 may include, among other things, a transmit/receive element 801 (for example an antenna), a transceiver 802, physical (PHY) circuitry 804, and media access control (MAC) circuitry 806. PHY circuitry 804 and MAC circuitry 806 may be HEW compliant layers and may also be compliant with one or more legacy IEEE 802.13 standards. MAC circuitry 806 may be arranged to configure packets such as a physical layer convergence procedure (PLCP) protocol data unit (PPDUs) and arranged to transmit and receive PPDUs, among other things. HEW device 800 may also include circuitry 808 and memory 810 configured to perform the various operations described herein. The circuitry 808 may be coupled to the transceiver 802, which may be coupled to the transmit/receive element 801. While FIG. 8 depicts the circuitry 808 and the transceiver 802 as separate components, the circuitry 808 and the transceiver 802 may be integrated together in an electronic package or chip.

In some embodiments, the MAC circuitry 806 may be arranged to contend for a wireless medium during a contention period to receive control of the medium for the HEW control period and configure an HEW PPDU. In some embodiments, the MAC circuitry 806 may be arranged to contend for the wireless medium based on channel contention settings, a transmitting power level, and a CCA level.

The PHY circuitry 804 may be arranged to transmit the HEW PPDU. The PHY circuitry 804 may include circuitry for modulation/demodulation, upconversion/downconversion, filtering, amplification, etc. In some embodiments, the circuitry 808 may include one or more processors. The circuitry 808 may be configured to perform functions based on instructions being stored in a RAM or ROM, or based on special purpose circuitry. The circuitry 808 may include processing circuitry and/or transceiver circuitry in accordance with some embodiments. The circuitry 808 may include a processor such as a general purpose processor or special purpose processor. The circuitry 808 may implement one or more functions associated with transmit/receive elements 801, the transceiver 802, the PHY circuitry 804, the MAC circuitry 806, and/or the memory 810.

In some embodiments, the circuitry 808 may be configured to perform one or more of the functions and/or methods described herein and/or in conjunction with FIGS. 1-8.

In some embodiments, the transmit/receive elements 801 may be two or more antennas that may be coupled to the PHY circuitry 804 and arranged for sending and receiving signals including transmission of the HEW packets. The transceiver 802 may transmit and receive data such as HEW PPDU and packets that include an indication that the HEW device 800 should adapt the channel contention settings according to settings included in the packet. The memory 810 may store information for configuring the other circuitry to perform operations for configuring and transmitting HEW packets and performing the various operations to perform one or more of the functions and/or methods described herein and/or in conjunction with FIGS. 1-8.

In some embodiments, the HEW device 800 may be configured to communicate using OFDM communication signals over a multicarrier communication channel. In some embodiments, HEW device 800 may be configured to communicate in accordance with one or more specific communication standards, such as the Institute of Electrical and Electronics Engineers (IEEE) standards including IEEE 802.11-2012, 802.11n-2009, 802.11ac-2013, 802.11ax, DensiFi, standards and/or proposed specifications for WLANs, or other standards as described in conjunction with FIG. 1, although the scope of the invention is not limited in this respect as they may also be suitable to transmit and/or receive communications in accordance with other techniques and standards. In some embodiments, the HEW device 800 may use 4× symbol duration of 802.11n or 802.11ac.

In some embodiments, an HEW device 800 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), an access point, a base station, a transmit/receive device for a wireless standard such as 802.11 or 802.16, or other device that may receive and/or transmit information wirelessly. In some embodiments, the mobile device may include one or more of a keyboard, a display, a non-volatile memory port, multiple antennas, a graphics processor, an application processor, speakers, and other mobile device elements. The display may be an LCD screen including a touch screen.

The transmit/receive element 801 may comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result.

Although the HEW device 800 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

Some embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. Those instructions may then be read and executed by one or more processors to cause the device 800 to perform the methods and/or operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The following examples pertain to further embodiments. Example 1 is an apparatus of a high-efficiency wireless local-area network (HEW) master station. The apparatus comprising transceiver circuitry and processing circuitry configured to generate a random access trigger frame (TF-R) that indicates one or more resource units (RUs) for random access and a number of time slots for the one or more RUs for random access, and transmit the TF-R to a plurality of HEW stations.

In Example 2, the subject matter of Example 1 can optionally include where the transceiver circuitry and processing circuitry is configured to: generate the TF-R that indicates the one or more RUs for random access and the number of time slots for the one or more RUs for each of one or more access categories.

In Example 3, the subject matter of Example 1 or Example 2 can optionally include where the TF-R comprises for each of the one or more access categories one or more from the following group: a contention window (CW) minimum value subfield, a number of resource units (RUs) subfield, a CW maximum value subfield, and a random access group identifier (ID), wherein the random access group identifier identifies a group of HEW stations of the plurality of HEW stations that are allowed to contend for the RUs for random access.

In Example 4, the subject matter of any of Examples 1-3 can optionally include where the TF-R comprises one or more from the following group: a contention window (CW) minimum value subfield, a number of resource units (RUs) subfield, a CW maximum value subfield and a random access group identifier (ID), wherein the random access group identifier identifies a group of HEW stations of the plurality of HEW stations that are allowed to contend for the RUs for random access.

In Example 5, the subject matter of any of Examples 1-4 can optionally include where the transceiver circuitry and processing circuitry is configured to: assign one or more HEW stations of the plurality of HEW stations to a random access group identified by a random access group identifier (ID).

In Example 6, the subject matter of any of Examples 1-5 can optionally include where the TF-R comprises a first access category subfield to indicate a category of HEW stations permitted to access the number of time slots.

In Example 7, the subject matter of Example 6 can optionally include where the TF-R comprises a second access category to indicate a second access category of HEW stations permitted to access a second number of time slots.

In Example 8, the subject matter of Example 7 can optionally include where the TF-R comprises one or more from the following group: a second contention window (CW) minimum value subfield for the second access category, a second number of resource units (RUs) subfield for the second access category, and a second CW maximum value subfield for the second access category.

In Example 9, the subject matter of Example 6 can optionally include where the first access category and the second access category are each one from the following group: a battery constrained device and a non-battery constrained device.

In Example 10, the subject matter of any of Examples 1-9 can optionally include where the TF-R comprises a first access category subfield to indicate a category of HEW stations permitted to access the number of time slots and one or more additional access category subfields and one or more number of time slots subfields. The one or more additional access category subfields may indicate the access category of HEW stations permitted to access the corresponding one or more number of time slots subfields.

In Example 11, the subject matter of Example 10 can optionally include where the TF-R further comprises one or more number of RUs wherein the one or more additional access category subfields indicate the category of HEW stations permitted to access the corresponding one or more number of RUs.

In Example 12, the subject matter of any of Examples 1-11 can optionally include where the transceiver circuitry and processing circuitry is configured to operate in accordance with Institute of Electrical and Electronic Engineers (IEEE) 802.11 ax.

In Example 13, the subject matter of any of Examples 1-12 can optionally include where the transceiver circuitry and processing circuitry is configured to: determine that the plurality of HEW stations are battery constrained HEW stations, determine a time the plurality of HEW stations will wake up from a power save mode, generate the TF-R with the number of time slots being based a number of the plurality of HEW stations, and after the time the plurality of HEW stations are to wake up, transmit the TF-R to a plurality of HEW stations.

In Example 14, the subject matter of any of Examples 1-14 can optionally include memory coupled to the transceiver circuitry and processing circuitry; and one or more antennas coupled to the transceiver circuitry and processing circuitry.

Example 15 is non-transitory computer-readable storage medium that stores instructions for execution by one or more processors. The instructions to configure the one or more processors to cause a high-efficiency wireless local-area network (HEW) master station to: receive a random access trigger frame (TF-R) that indicates one or more resource units (RUs) for random access and a number of time slots for the one or more RUs, randomly select a RU for random access and time slot to transmit, transmit a packet in accordance with the RU for random access and the time slot.

In Example 16, the subject matter of Example 15 can optionally include where the instructions are to configure the one or more processors to cause the HEW master station to: generate the TF-R that indicates the one or more RUs for random access and the number of time slots for the one or more RUs for random access for each of a plurality of access categories.

In Example 17, the subject matter of Example 15 or Example 16 can optionally include where the TF-R comprises for each of the plurality of access categories one or more from the following group: a contention window (CW) minimum value subfield, a number of resource units (RUs) subfield, and a CW maximum value subfield.

In Example 18, the subject matter of Example 17 can optionally include where the TF-R comprises a second access category to indicate a second access category of HEW stations permitted to access a second number of time slots.

Example 19 is an apparatus of a high-efficiency wireless local-area network (HEW) station. The apparatus comprising circuitry configured to receive a random access trigger frame (TF-R) that indicates one or more resource units (RUs) and a number of time slots for the one or more RUs, set a backoff count based on the TF-R, and contend for at least one RU based on the backoff count.

In Example 20, the subject matter of Example 19 can optionally include where the TF-R further indicates the one or more RUs and the number of time slots for the one or more RUs for each of one or more access categories, and wherein the transceiver circuitry and processing circuitry is configured to: determine an access category of the HEW station, and contend for the at least one RU based on the backoff count, if the one or more access categories indicate that the access category of the HEW station permits the HEW station to contend for the at least one RU.

In Example 21, the subject matter of Example 20 can optionally include where the TF-R comprises for each of the one or more access categorie a contention window (CW) minimum value subfield, a number of resource units (RUs) subfield, and a CW maximum value subfield, and wherein the transceiver circuitry and processing circuitry is configured to: set the backoff count based on the CW minimum value and the CW maximum corresponding to the access category of the HEW station.

In Example 22, the subject matter of any of Examples 19-21 can optionally include where the TF-R further indicates a random access group identifier (ID), and wherein the transceiver circuitry and processing circuitry are configured to: contend for the at least one RU based on the backoff count, if the HEW station is a member of the group identified by the random access group ID.

In Example 23, the subject matter of any of Examples 19-22 can optionally include memory coupled to the transceiver circuitry and processing circuitry; and one or more antennas coupled to the transceiver circuitry and processing circuitry.

Example 24 is a method performed by a high-efficiency wireless local-area network (HEW) master station. The method including generating a random access trigger frame (TF-R) that indicates one or more resource units (RUs) for random access and a number of time slots for the one or more RUs for random access, and transmitting the TF-R to a plurality of HEW stations.

In Example 25, the subject matter of Example 25 can optionally include generating the TF-R that indicates the one or more RUs and the number of time slots for the one or more RUs for random access for each of one or more access categories.

Example 26 is an apparatus of a high-efficiency wireless local-area network (HEW) master station. The apparatus including means for generating a random access trigger frame (TF-R) that indicates one or more resource units (RUs) for random access and a number of time slots for the one or more RUs for random access, and means for transmitting the TF-R to a plurality of HEW stations.

In Example 27, the subject matter of Example 26 can optionally include where the apparatus further comprises: means for generating the TF-R that indicates the one or more RUs for random access and the number of time slots for the one or more RUs for each of one or more access categories.

In Example 28, the subject matter of Example 27 or Example 28 can optionally include where the TF-R comprises for each of the one or more access categories one or more from the following group: a contention window (CW) minimum value subfield, a number of resource units (RUs) subfield, a CW maximum value subfield, and a random access group identifier (ID). The random access group identifier may identify a group of HEW stations of the plurality of HEW stations that are allowed to contend for the RUs for random access.

In Example 29, the subject matter of any of Examples 26-28 can optionally include where the TF-R comprises one or more from the following group: a contention window (CW) minimum value subfield, a number of resource units (RUs) subfield, a CW maximum value subfield and a random access group identifier (ID), wherein the random access group identifier identifies a group of HEW stations of the plurality of HEW stations that are allowed to contend for the RUs for random access.

In Example 30, the subject matter of any of Examples 26-29 can optionally include means for assigning one or more HEW stations of the plurality of HEW stations to a random access group identified by a random access group identifier (ID).

In Example 31, the subject matter of any of Examples 26-30 can optionally include where the TF-R comprises a first access category subfield to indicate a category of HEW stations permitted to access the number of time slots.

In Example 32, the subject matter of Examples 31 can optionally include where the TF-R comprises a second access category to indicate a second access category of HEW stations permitted to access a second number of time slots.

In Example 33, the subject matter of Example 32 can optionally include where the TF-R comprises one or more from the following group: a second contention window (CW) minimum value subfield for the second access category, a second number of resource units (RUs) subfield for the second access category, and a second CW maximum value subfield for the second access category.

In Example 34, the subject matter of Example 31 can optionally include where the first access category and the second access category are each one from the following group: a battery constrained device and a non-battery constrained device.

In Example 35, the subject matter of any of Examples 26-34 can optionally include where the TF-R comprises a first access category subfield to indicate a category of HEW stations permitted to access the number of time slots and one or more additional access category subfields and one or more number of time slots subfields, wherein the one or more additional access category subfields indicate the access category of HEW stations permitted to access the corresponding one or more number of time slots subfields.

In Example 36, the subject matter of Example 35 can optionally include where the TF-R further comprises one or more number of RUs wherein the one or more additional access category subfields indicate the category of HEW stations permitted to access the corresponding one or more number of RUs.

In Example 37, the subject matter of any of Examples 26-36 can optionally include means for operating in accordance with Institute of Electrical and Electronic Engineers (IEEE) 802.11 ax.

In Example 38, the subject matter of any of Examples 26-37 can optionally include means for determining that the plurality of HEW stations are battery constrained HEW stations, means for determining a time the plurality of HEW stations will wake up from a power save mode, means for generating the TF-R with the number of time slots being based a number of the plurality of HEW stations, and means for transmitting the TF-R to a plurality of HEW stations after the time the plurality of HEW stations are to wake up.

In Example 39, the subject matter of any of Examples 26-38 can optionally include means for transmitting and receiving radio frequency signals coupled to means for processing radio frequency signals.

Example 40 is an apparatus of a high-efficiency wireless local-area network (HEW) station. The apparatus including means for receiving a random access trigger frame (TF-R) that indicates one or more resource units (RUs) and a number of time slots for the one or more RUs, means for setting a backoff count based on the TF-R, and means for contending for at least one RU based on the backoff count.

In Example 41, the subject matter of Example 41 can optionally include where the TF-R further indicates the one or more RUs and the number of time slots for the one or more RUs for each of one or more access categories, and wherein the apparatus further includes means for determining an access category of the HEW station, and means for contending for the at least one RU based on the backoff count, if the one or more access categories indicate that the access category of the HEW station permits the HEW station to contend for the at least one RU.

In Example 42, the subject matter of Example 40 can optionally include where the TF-R comprises for each of the one or more access categories a contention window (CW) minimum value subfield, a number of resource units (RUs) subfield, and a CW maximum value subfield, and wherein the apparatus further comprises means for setting the backoff count based on the CW minimum value and the CW maximum corresponding to the access category of the HEW station.

In Example 43, the subject matter of any of Examples 40-42 can optionally include where the TF-R further indicates a random access group identifier (ID), and the apparatus further including means for contending for the at least one RU based on the backoff count, if the HEW station is a member of the group identified by the random access group ID.

In Example 44, the subject matter of any of Examples 40-43 can optionally include means for transmitting and receiving radio frequency signals coupled to means for processing radio frequency signals.

Example 45 is a non-transitory computer-readable storage medium that stores instructions for execution by one or more processors. The instructions to configure the one or more processors to cause a high-efficiency wireless local-area network (HEW) station to: receive a random access trigger frame (TF-R) that indicates one or more resource units (RUs) and a number of time slots for the one or more RUs, and set a backoff count based on the TF-R, and contend for at least one RU based on the backoff count.

In Example 46, the subject matter of Example 45 can optionally include where the TF-R further indicates the one or more RUs and the number of time slots for the one or more RUs for each of one or more access categories, and wherein the instructions configure the one or more processors to cause a high-efficiency wireless local-area network (HEW) station to: determine an access category of the HEW station, contend for the at least one RU based on the backoff count, if the one or more access categories indicate that the access category of the HEW station permits the HEW station to contend for the at least one RU.

In Example 47, the subject matter of Examples 45 can optionally include where the TF-R comprises for each of the one or more access categories a contention window (CW) minimum value subfield, a number of resource units (RUs) subfield, and a CW maximum value subfield, and wherein the instructions configure the one or more processors to cause a high-efficiency wireless local-area network (HEW) station to: set the backoff count based on the CW minimum value and the CW maximum corresponding to the access category of the HEW station.

In Example 48, the subject matter of any of Examples 45-47 can optionally include where the TF-R further indicates a random access group identifier (ID), and wherein the instructions configure the one or more processors to cause a high-efficiency wireless local-area network (HEW) station to: contend for the at least one RU based on the backoff count, if the HEW station is a member of the group identified by the random access group ID.

Example 49 is a method performed by a high-efficiency wireless local-area network (HEW) station. The method including receiving a random access trigger frame (TF-R) that indicates one or more resource units (RUs) and a number of time slots for the one or more RUs, setting a backoff count based on the TF-R, and contending for at least one RU based on the backoff count.

In Example 50, the subject matter of Examples 49 can optionally include where the TF-R further indicates the one or more RUs and the number of time slots for the one or more RUs for each of one or more access categories, and the method further comprising: determining an access category of the HEW station; and contending for the at least one RU based on the backoff count, if the one or more access categories indicate that the access category of the HEW station permits the HEW station to contend for the at least one RU.

In Example 51, the subject matter of Example 50 can optionally include where the TF-R comprises for each of the one or more access categories a contention window (CW) minimum value subfield, a number of resource units (RUs) subfield, and a CW maximum value subfield, and wherein the method further comprises: setting the backoff count based on the CW minimum value and the CW maximum corresponding to the access category of the HEW station.

In Example 52, the subject matter of any of Examples 49-51 can optionally include where the TF-R further indicates a random access group identifier (ID), and wherein the method further comprises: contending for the at least one RU based on the backoff count, if the HEW station is a member of the group identified by the random access group ID.

Example 53 is a non-transitory computer-readable storage medium that stores instructions for execution by one or more processors. The instructions to configure the one or more processors to cause a high-efficiency wireless local-area network (HEW) master station to: generate a random access trigger frame (TF-R) that indicates one or more resource units (RUs) for random access and a number of time slots for the one or more RUs for random access, and transmit the TF-R to a plurality of HEW stations.

In Example 54, the subject matter of Example 53 can optionally include where the instructions to configure the one or more processors to cause the HEW master station to: instructions transceiver circuitry and processing circuitry is configured to: generate the TF-R that indicates the one or more RUs for random access and the number of time slots for the one or more RUs for each of one or more access categories.

In Example 55, the subject matter of Examples 53 or 54 can optionally include where the TF-R comprises for each of the one or more access categories one or more from the following group: a contention window (CW) minimum value subfield, a number of resource units (RUs) subfield, a CW maximum value subfield, and a random access group identifier (ID), wherein the random access group identifier identifies a group of HEW stations of the plurality of HEW stations that are allowed to contend for the RUs for random access.

In Example 56, the subject matter of any of Examples 53-55 can optionally include where the TF-R comprises one or more from the following group: a contention window (CW) minimum value subfield, a number of resource units (RUs) subfield, a CW maximum value subfield and a random access group identifier (ID), wherein the random access group identifier identifies a group of HEW stations of the plurality of HEW stations that are allowed to contend for the RUs for random access.

In Example 57, the subject matter of any of Examples 53-56 can optionally include where the transceiver circuitry and processing circuitry is configured to: assign one or more HEW stations of the plurality of HEW stations to a random access group identified by a random access group identifier (ID).

In Example 58, the subject matter of any of Examples 53-57 can optionally include where the TF-R comprises a first access category subfield to indicate a category of HEW stations permitted to access the number of time slots.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus of a high-efficiency wireless local-area network (HEW) master station, the apparatus comprising transceiver circuitry and processing circuitry configured to:
generate a random access trigger frame (TF-R) that indicates one or more resource units (RUs) for random access and a number of time slots for the one or more RUs for random access; and
transmit the TF-R to a plurality of HEW stations.

2. The apparatus of claim 1, wherein the transceiver circuitry and processing circuitry is configured to:
generate the TF-R that indicates the one or more RUs for random access and the number of time slots for the one or more RUs for random access for each of one or more access categories.

3. The apparatus of claim 2, wherein the TF-R comprises for each of the one or more access categories one or more from the following group: a contention window (CW) minimum value subfield, a number of resource units (RUs) subfield, a CW maximum value subfield, and a random access group identifier (ID), wherein the random access group identifier identifies a group of HEW stations of the plurality of HEW stations that are allowed to contend for the RUs for random access.

4. The apparatus of claim 1, wherein the TF-R comprises one or more from the following group: a contention window (CW) minimum value subfield, a number of resource units (RUs) subfield, a CW maximum value subfield and a random access group identifier (ID), wherein the random access group identifier identifies a group of HEW stations of the plurality of HEW stations that are allowed to contend for the RUs for random access.

5. The apparatus of claim 1, wherein the transceiver circuitry and processing circuitry is configured to:
assign one or more HEW stations of the plurality of HEW stations to a random access group identified by a random access group identifier (ID).

6. The apparatus of claim 1, wherein the TF-R comprises a first access category subfield to indicate a category of HEW stations permitted to access the number of time slots.

7. The apparatus of claim 6, wherein the TF-R comprises a second access category to indicate a second access category of HEW stations permitted to access a second number of time slots.

8. The apparatus of claim 7, wherein the TF-R comprises one or more from the following group: a second contention window (CW) minimum value subfield for the second access category, a second number of resource units (RUs) subfield for the second access category, and a second CW maximum value subfield for the second access category.

9. The apparatus of claim 6, wherein the first access category and the second access category are each one from the following group: a battery constrained device and a non-battery constrained device.

10. The apparatus of claim 1, wherein the TF-R comprises a first access category subfield to indicate a category of HEW stations permitted to access the number of time slots and one or more additional access category subfields and one or more number of time slots subfields, wherein the one or more additional access category subfields indicate the access category of HEW stations permitted to access the corresponding one or more number of time slots subfields.

11. The apparatus of claim 9, wherein the TF-R further comprises one or more number of RUs wherein the one or more additional access category subfields indicate the category of HEW stations permitted to access the corresponding one or more number of RUs.

12. The apparatus of claim 1, wherein the transceiver circuitry and processing circuitry is configured to operate in accordance with Institute of Electrical and Electronic Engineers (IEEE) 802.11ax.

13. The apparatus of claim 1, wherein the transceiver circuitry and processing circuitry is configured to:
determine that the plurality of HEW stations are battery constrained HEW stations;
determine a time the plurality of HEW stations will wake up from a power save mode;
generate the TF-R with the number of time slots being based a number of the plurality of HEW stations; and
after the time the plurality of HEW stations are to wake up, transmit the TF-R to a plurality of HEW stations.

14. The apparatus of claim 1 further comprising memory coupled to the transceiver circuitry and processing circuitry; and one or more antennas coupled to the transceiver circuitry and processing circuitry.

15. A non-transitory computer-readable storage medium that stores instructions for execution by one or more processors, the instructions to configure the one or more processors to cause a high-efficiency wireless local-area network (HEW) master station to:
receive a random access trigger frame (TF-R) that indicates one or more resource units (RUs) for random access and a number of time slots for the one or more RUs;
randomly select a RU for random access and time slot to transmit; and
transmit a packet in accordance with the RU for random access and the time slot.

16. The non-transitory computer-readable storage medium of claim 15, wherein the instructions are to configure the one or more processors to cause the HEW master station to:
generate the TF-R that indicates the one or more RUs for random access and the number of time slots for the one or more RUs for random access for each of a plurality of access categories.

17. The non-transitory computer-readable storage medium of claim 15, wherein the TF-R comprises for each of the plurality of access categories one or more from the following group: a contention window (CW) minimum value subfield, a number of resource units (RUs) subfield, and a CW maximum value subfield.

18. The non-transitory computer-readable storage medium of claim 17, wherein the TF-R comprises a second access category to indicate a second access category of HEW stations permitted to access a second number of time slots.

19. An apparatus of a high-efficiency wireless local-area network (HEW) station, the apparatus comprising circuitry configured to:
receive a random access trigger frame (TF-R) that indicates one or more resource units (RUs) and a number of time slots for the one or more RUs;
set a backoff count based on the TF-R; and
contend for at least one RU based on the backoff count.

20. The apparatus of claim 19, wherein the TF-R further indicates the one or more RUs and the number of time slots for the one or more RUs for each of one or more access categories, and wherein the transceiver circuitry and processing circuitry is configured to:
determine an access category of the HEW station; and
contend for the at least one RU based on the backoff count, if the one or more access categories indicate that the access category of the HEW station permits the HEW station to contend for the at least one RU.

21. The apparatus of claim 20, wherein the TF-R comprises for each of the one or more access categories a contention window (CW) minimum value subfield, a number of resource units (RUs) subfield, and a CW maximum value subfield, and wherein the transceiver circuitry and processing circuitry is configured to:
set the backoff count based on the CW minimum value and the CW maximum corresponding to the access category of the HEW station.

22. The apparatus of claim 19, wherein the TF-R further indicates a random access group identifier (ID), and wherein the transceiver circuitry and processing circuitry are configured to:
contend for the at least one RU based on the backoff count, if the HEW station is a member of the group identified by the random access group ID.

23. The apparatus of claim 19, further comprising memory coupled to the transceiver circuitry and processing circuitry; and one or more antennas coupled to the transceiver circuitry and processing circuitry.

24. A method performed by a high-efficiency wireless local-area network (HEW) master station, the method comprising:
generating a random access trigger frame (TF-R) that indicates one or more resource units (RUs) for random access and a number of time slots for the one or more RUs for random access; and
transmitting the TF-R to a plurality of HEW stations.

25. The method of claim 24, further comprising:
generating the TF-R that indicates the one or more RUs and the number of time slots for the one or more RUs for random access for each of one or more access categories.
